(19) United States
(12) Patent Application Publication
(10) Pub. No.: US 2009/0288029 A1
(43) Pub. Date: Nov. 19, 2009

(54) DISPLAY SYSTEM WITH USER OPTIONS

(76) Inventors: Bruce Gordon Fuller, Edmonton (CA); Brian Alexander Wall, White Rock (CA); Kevin George Gordon, Vancouver (CA); Mark David Hobbs, Hartford, WI (US); Mohamed Salehmohamed, Surrey (CA)

Correspondence Address: ROCKWELL AUTOMATION, INC/SR, 1201 SOUTH SECOND STREET, MAIL STOP E-F719, MILWAUKEE, WI, 53204, US

(21) Appl. No.: 12/123,177

(22) Filed: May 19, 2008

(51) Int. Cl. G06F 3/048

(52) U.S. Cl. 715/771

(57) ABSTRACT

A method of displaying automation data is provided. First individual data points correlated with individual time points are received from a machine system. The first individual data points are stored in correlation with the individual time points. A user input is received indicating a selected time. The selected time is processed to determine if any of the individual time points are later in time than the selected time. In response to determining that none o the individual time points are later in time than the selected time, a graphical representation of second individual data points from the machine system are displayed. In response to determining that a one of the individual time points is later in time than the selected time, a graphical representation of at least the individual data point correlated with the selected time is displayed.

### TECHNICAL FIELD

The invention is related to the field of industrial automation, and in particular, to display automation data.

### TECHNICAL BACKGROUND

Industrial environments include automobile manufacturing factories, food processing plants, and microprocessor fabrication facilities. The typical industrial environment includes various machines, such as pumps, motors, and robots. These machines continually produce data that indicates the current status of the machines, such as the machine's pressure, temperature, or speed.

The typical industrial environment also includes a computer system with a user display system. The computer system receives and processes the status data from the machines to generate various graphical representations. The graphical representations indicate the current and historical status of the machines. For example, a graphical representation might indicate the pressure of a pump, the speed of a motor, or the output of a robot.

The computer system with the user display system allows a user to view the graphical representation of the status data from the machines in the industrial environment. The graphical representation is continuously generated from a live data feed. Unfortunately, status data in the graphical representation can be missed at times when the user must look away from the display system. For example, if the user needs a break or must react to an emergency, then they will not see all of the status data on the display system. An important event within the industrial environment might be overlooked in this manner.

### TECHNICAL SUMMARY

In one embodiment, a method of displaying automation data is provided. First individual data points correlated with individual time points are received from a machine system. The first individual data points are stored in correlation with the individual time points. A user input is received indicating a selected time. The selected time is processed to determine if any of the individual time points are later in time than the selected time. In response to determining that none of the individual time points are later in time than the selected time, a graphical representation of second individual data points from the machine system are displayed. In response to determining that a one of the individual time points is later in time than the selected time, a graphical representation of at least the individual data point correlated with the selected time is displayed.

In another embodiment, a display system is provided which includes a machine system, a user, and a computer system. The computer system receives first individual data points correlated with individual time points from the machine system. The computer system then stores the first individual data points in correlation with the individual time points. The computer system also receives a user input from the user indicating a selected time. The computer system then processes the selected time to determine if any of the individual time points are later in time than the selected time. In response to determining that none of the individual time points are later in time than the selected time, the computer system displays a graphical representation of second individual data points from the machine system. In response to determining that a one of the individual time points is later in time than the selected time, the computer system displays a graphical representation of at least the individual data point correlated with the selected time.

Additional embodiments and advantages of the present invention will be ascertained by those skilled in the art upon perusal of the following detailed description, taken in conjunction with the accompanying drawings.

### BRIEF DESCRIPTION OF THE DRAWINGS

FIG. 1 is a flow diagram illustrating a method of displaying automation data.

FIG. 2 is a block diagram of an exemplary embodiment for displaying automation data.

FIG. 3 is a block diagram illustrating a computer system.

FIG. 4 is a flow diagram illustrating a method of displaying automation data.

FIG. 5 is a block diagram illustrating software.

FIG. 6A is a sequence diagram illustrating the operation of displaying automation data.

FIG. 6B is a sequence diagram illustrating the operation of displaying automation data.

FIG. 7 is a display diagram illustrating a graphical representation of status data.

FIG. 8A is a display diagram illustrating a graphical representation of status data.

FIG. 8B is a display diagram illustrating a graphical representation of status data.

### DETAILED DESCRIPTION

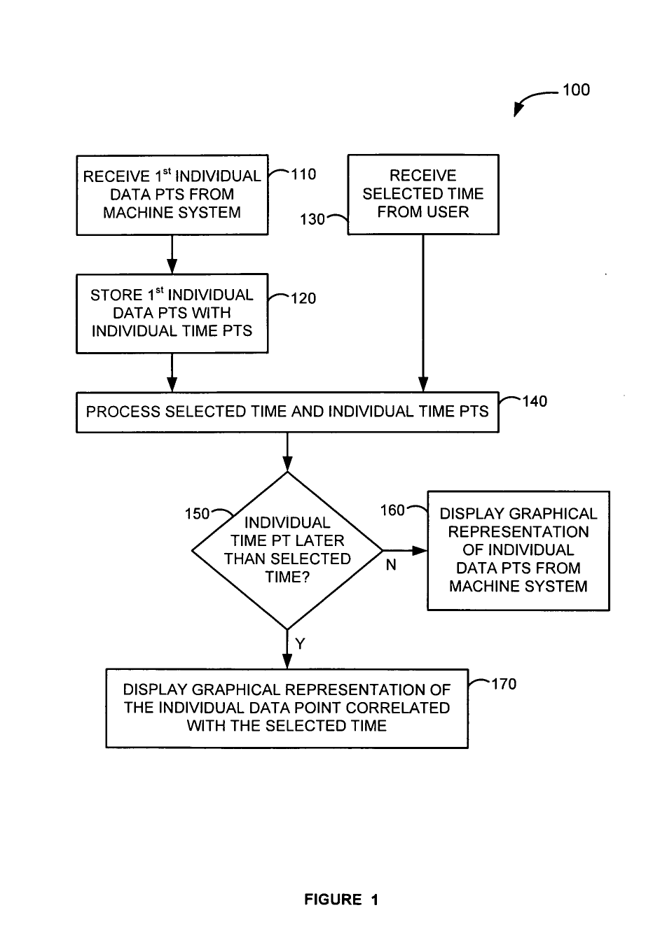

FIG. 1 is a flow diagram illustrating method 100 for displaying automation data. In method 100, substantially real-time information is received from a machine system and stored on a computer system (operations 110-120). Substantially real-time information refers to data coming from a live feed or a live feed with a negligible processing delay. The real-time information comprises status data (individual data points) over time (individual time points) related to an industrial environment, such as pressure, temperature, speed, or some other status metrics. The machine system continually transfers the substantially real-time information to the computer system.

The computer system also receives a user input which indicates a selected time for viewing (operation 130). There are various options available to a user to facilitate selecting a time for viewing. These options will be discussed in later embodiments.

After the user input indicating a selected time is received in the computer system, the computer system processes the selected time and the individual time points to determine if any of the individual time points stored on the computer system are later in time than the selected time (operation 140).

If no individual time points stored on the computer system are later in time than the selected time (operation 150), then the computer system displays a graphical representation of the substantially real-time information continuously received from the machine system (operation 160). However, if there is at least one individual time point stored on the computer system that is later in time than the user selected time, then the computer system displays a graphical representation of the stored status data that correlates with the selected time (operation 170).

Another embodiment provides for a computer-readable medium comprising instructions executable on a processor for employing method 100.

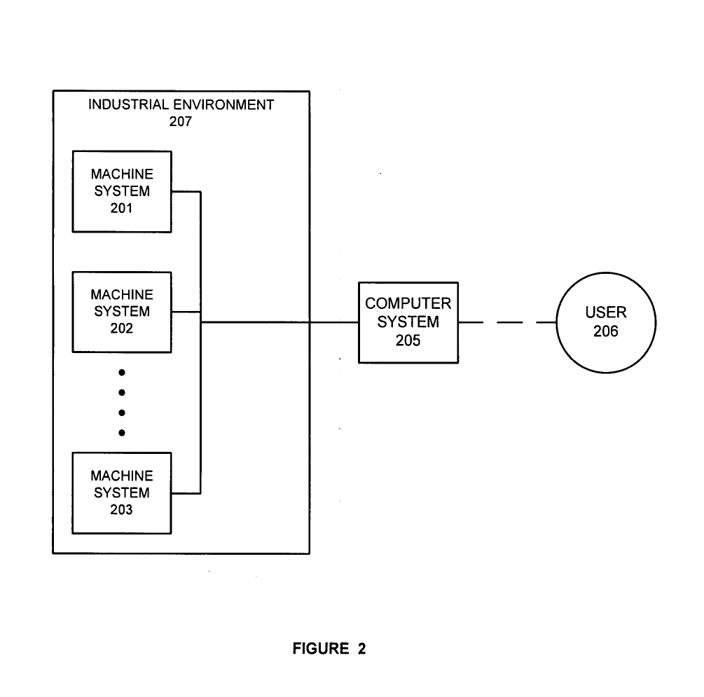

FIG. 2 is a block diagram of an exemplary embodiment for displaying automation data. FIG. 2 includes industrial environment 207, computer system 205, and user 206. Industrial environment 207 comprises machine systems 201-203. Machine systems 201-203 are coupled to computer system 205. Computer system 205 and user 206 communicate through various user interfaces. The number of machine systems, computer systems, and users shown in FIG. 2 has been restricted for clarity, but there would typically be many more.

Industrial environment 207 comprises an automobile manufacturing factory, food processing plant, microprocessor fabrication facility, or some other type of industrial enterprise. Machine systems 201-203 may be a processing unit of an automated process line, such as that which may be found in a factory automation or industrial process environment. Machine systems 201-203 comprise pumps, compressors, condensers, motors, robots, or some other mechanical apparatus, including their associated control systems. Machine systems 201-203 continually produce status data over time. The status data indicates the current status of machine systems 201-203, such as pressure, temperature, speed, flow rate, or some other status metrics. Machine systems 201-203 continually transfer the status data to computer system 205 via a local area network, wide area network, or some other communication link.

Computer system 205 comprises computer and communication equipment and software. Computer system 205 continually receives the status data from machine systems 201-203. Computer system 205 processes the status data to generate various graphical displays indicating the current and historical status of machine systems 201-203. For example, a graphical display might indicate the pressure of a pump, the speed of a motor, the output of a robot, or some other status metric. Computer system 205 also controls machine systems 201-203. For example, computer system 205 might turn on a pump, speed up a motor, stop a robot, or perform some other type of machine control. An example of a computer system that could be adapted in accord with this description is RSView™ supplied by Rockwell Automation.

User 206 comprises a human operator, a remote operator, or may communication with a control element.

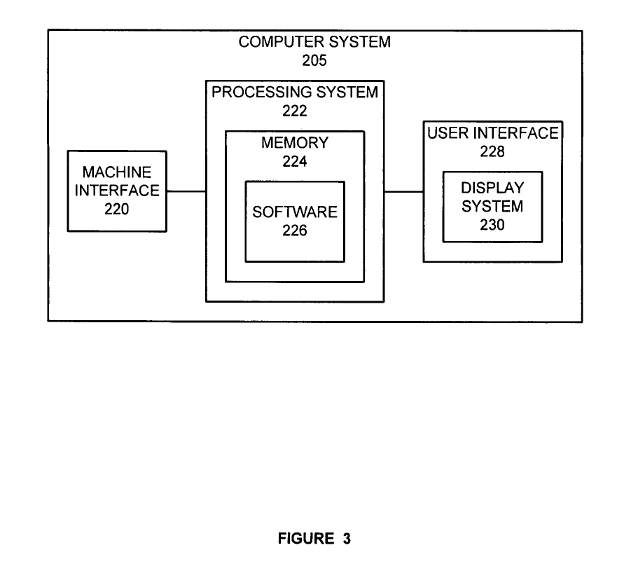

FIG. 3 is a block diagram illustrating computer system 205. Computer system 205 comprises machine interface 220, processing system 222, and user interface 228. Processing system 222 comprises memory 224. Memory 224 stores software 226. User interface 228 comprises display system 230. Processing system 222 is coupled to machine interface 220 and user interface 228. Other components often associated with computer systems, such as interface ports, external media drives, and the like, are not shown to simplify the following discussion. Also, while a single computer system 205 is described herein, other systems employing multiple computers coupled together to form a distributed system may be used in other embodiments to perform the various tasks described below in connection with computer system 205.

Machine interface 220 comprises communication circuitry and equipment that communicates with machine systems 201-203 (from FIG. 2). Machine interface 220 is in communication with machine systems 201-203 over wireless, metallic, or optical media. Machine interface 220 comprises a transceiver, port, antenna, circuitry, or other communication components. Machine interface 220 may use Ethernet, Internet Protocol, Wireless Fidelity, or some other communication protocol.

Processing system 222 comprises microprocessors or other logic circuitry that retrieve and execute software 226. Memory 224 comprises a disk, integrated circuit, flash drive, or some other memory device. Memory 224 may include Random Access Memory (RAM), Read-Only Memory (ROM), Hard Disk Drive (HDD) memory, and other forms of memory, both volatile and nonvolatile. Software 226 comprises an operating system, utilities, drivers, networking software, application programs, firmware, or some other form of machine-readable processing instructions. When executed by processing system 222, software 226 directs processing system 222 to operate as described herein.

User interface 228 comprises a keyboard, mouse, speaker, microphone, voice recognition interface, touch screen, control buttons, control switches, or some other user device. Display system 230 comprises a liquid crystal display, cathode ray tube display, or some other graphical display mechanism. The above-described components (220-230) of computer system 205 may be integrated together or distributed among multiple devices.

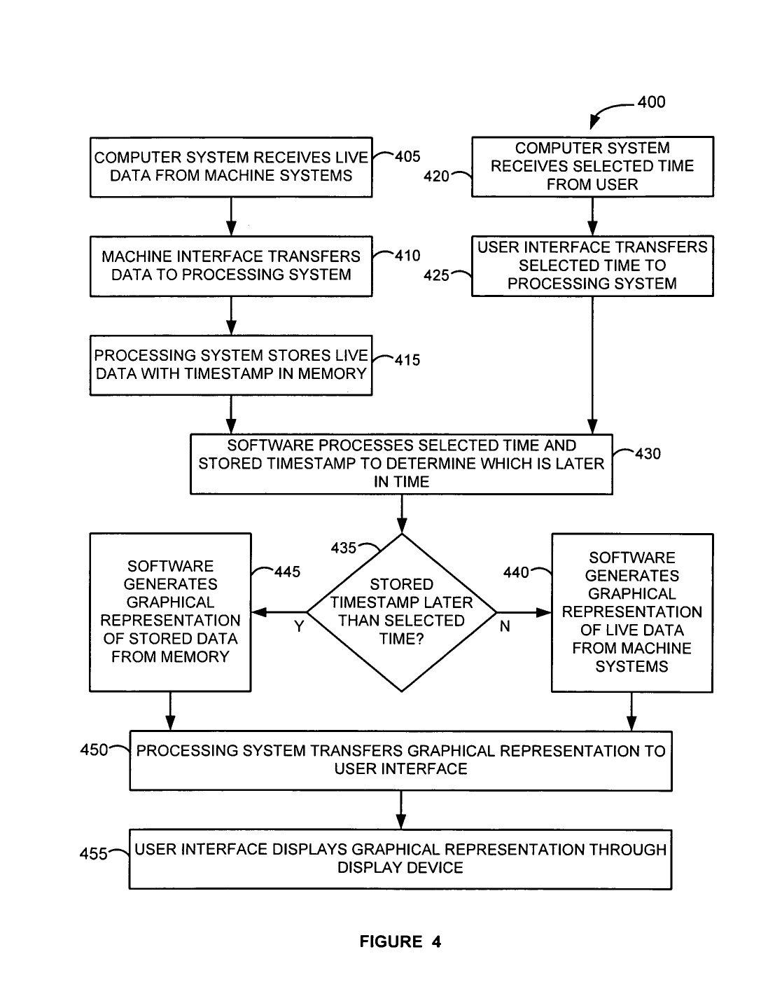

FIG. 4 is a flow diagram illustrating method 400 for operation of computer system 205. Machine interface 220 receives substantially live status data from machine systems 201-203 (operation 405).

Processing system 222 receives a live status data stream from machine interface 220 (operation 410). Processing system 222 then correlates the live status data with a timestamp and datestamp and transfers the data to memory 224 (operation 415).

User interface 228 receives input from human operator 206 indicating a selected time for viewing data (operation 420). Processing system 222 receives the selected time from user interface 228 (operation 425).

In response to receiving the selected time, processing system 222 retrieves and executes software 226 from memory 224. When executed by processing system 222, software 226 directs processing system 222 to operate as described herein. Processing system 222 processes the selected time and the last stored timestamp to determine which is later in time (operation 430).

If the selected time indicated by human operator 206 is later in time than the last stored timestamp (operation 435), then processing system 222 generates a graphical representation of the live status data stream from machine systems 201-203 (operation 440). If the last stored timestamp is later in time than the selected time indicated by human operator 206 (operation 435), then processing system 222 generates a graphical representation of the stored status data from memory 224 that correlates to the selected time (operation 445).

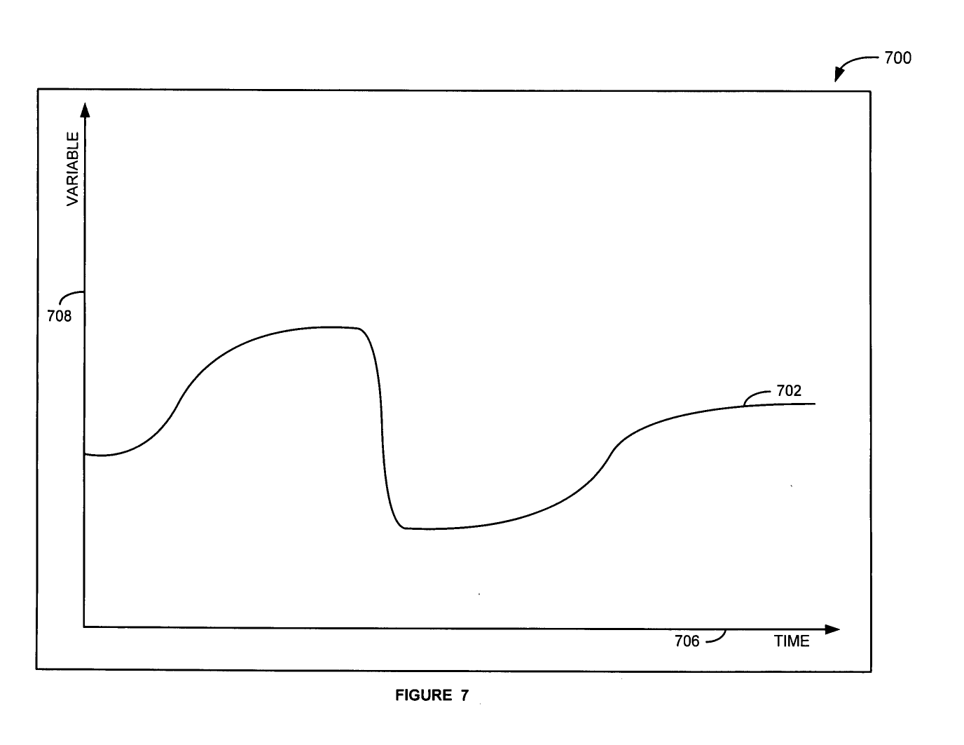

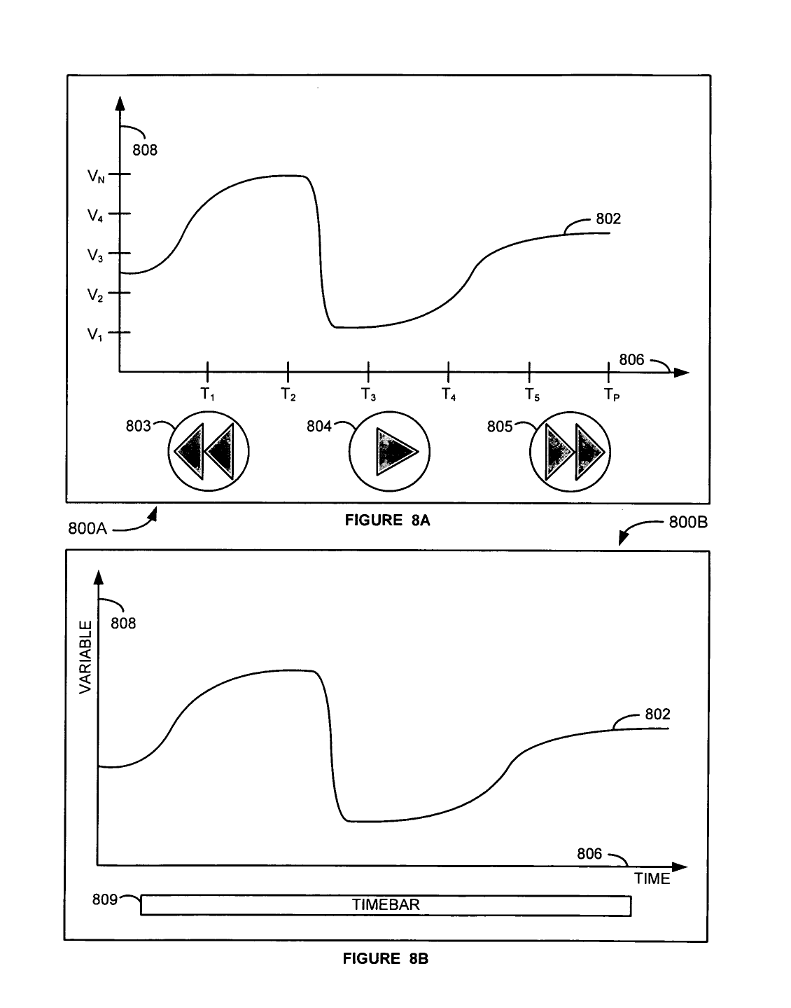

Processing system 222 transfers the graphical representation of either the live status data stream or the stored status data to user interface 228 (operation 450). User interface 228 then displays the graphical representation of either the stored status data or the live status data stream by way of display system 230 (operation 455). Display system 230 displays the status data plotted against time to human operator 206. Display system 230 is discussed in further detail in FIGS. 7, 8A, and 8B.

Another embodiment provides for a computer-readable medium comprising instructions executable on a processor for employing method 400.

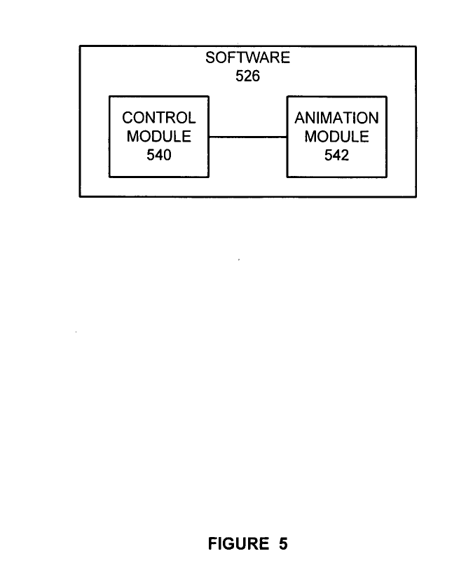

FIG. 5 is a functional block diagram illustrating software 526. When executed by processing system 222, software 526 directs processing system 222 to operate as described herein. Software 526 comprises control module 540 and animation module 542. Control module 540 is coupled to animation module 542. Control module 540 may include an operating system, utilities, drivers, networking, and applications. Control module 540 is configured to direct computer system 205 to operate as described herein. Animation module 542 comprises an application configured to generate a graphical representation of the live or stored status data.

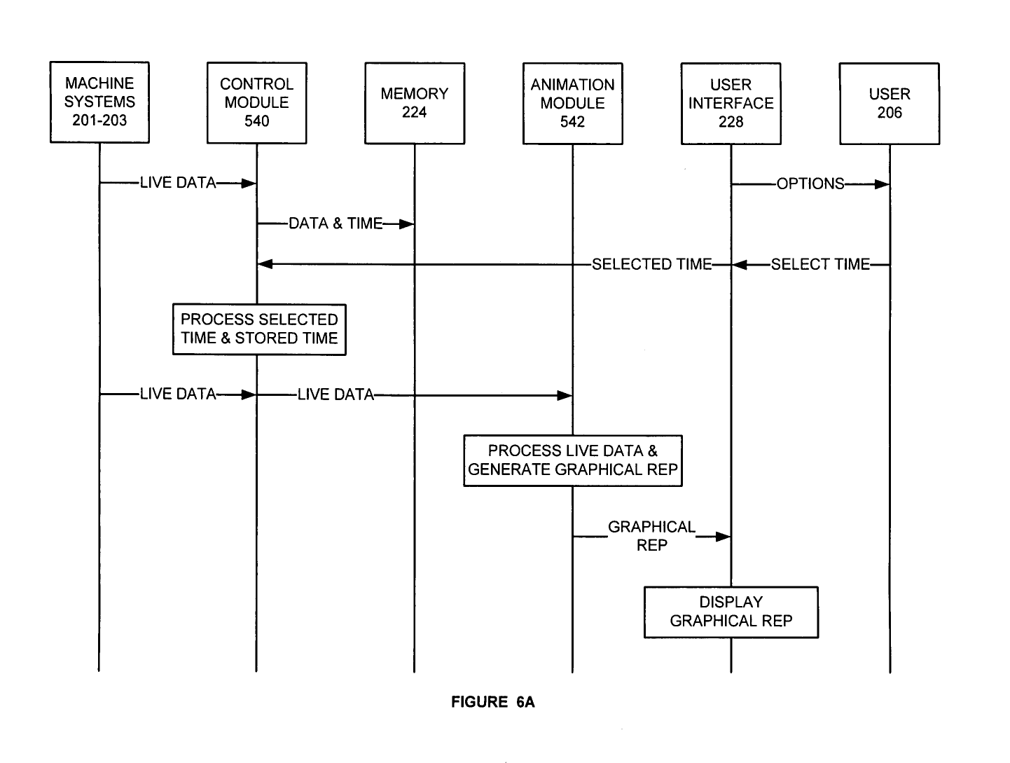

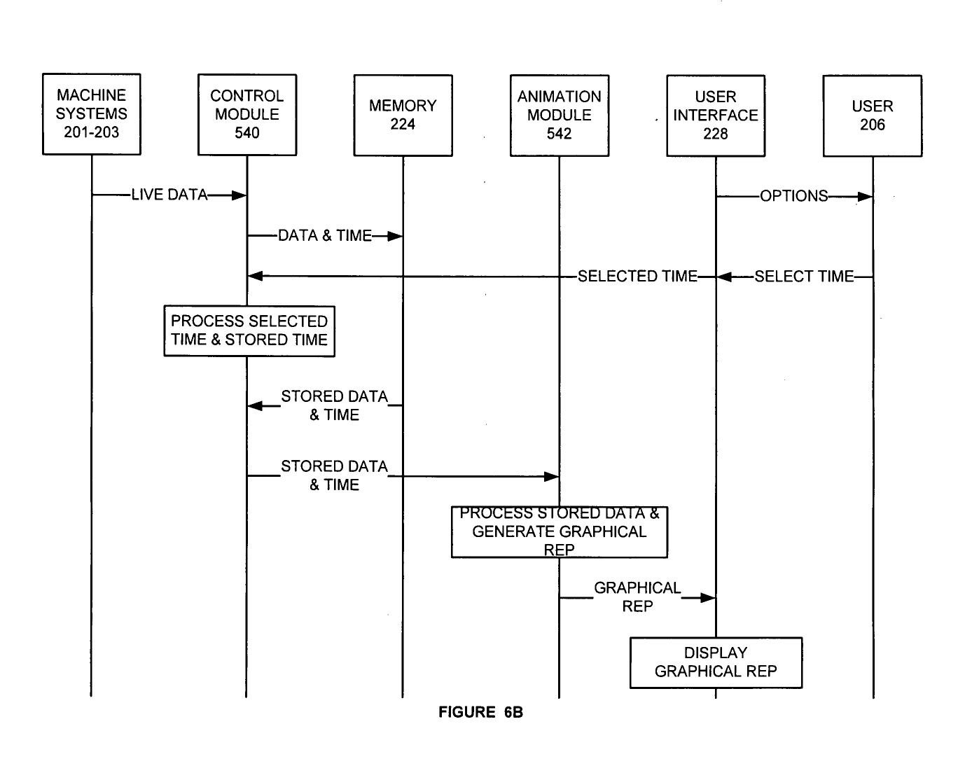

FIG. 6A is a sequence diagram illustrating the operation of displaying automation data. When executed by processing system 222, control module 540 and animation module 542 direct processing system 222 to operate as described herein. Machine systems 201-203 continuously transfer live status data to control module 540. As control module 540 receives the live status data from machine systems 201-203, it timestamps and datestamps the status data and stores the status data with the corresponding timestamp and datestamp in memory 224.

Simultaneously, user interface 228 communicates various options to user 206. User 206 responds by selecting a time for viewing the status data. User interface 228 transfers the selected time to control module 540. Control module 540 then processes the selected time and the stored timestamps to determine whether user 206 is requesting a view of a graphical representation of current (live) status data or past (stored) status data.

In this example, user 206 indicates the current time as the selected time for viewing. Control module 540 transfers the live status data from machine systems 201-203 to animation module 542. Animation module 542 processes the live status data and generates a graphical representation of the live status data. User interface 228 then receives the graphical representation of the live status data and displays the graphical representation for user 206 to view.

Display system 200 continues to display a graphical representation of the live status data from machine systems 201-203 until user 206 selects a different option.

FIG. 6B is a sequence diagram illustrating the operation of displaying automation data. Machine systems 201-203 continuously transfer live status data to control module 540. As control module 540 receives the live status data from machine systems 201-203, it timestamps and datestamps the status data and stores the status data with the corresponding timestamp and datestamp in memory 224.

Simultaneously, user interface 228 communicates various options to user 206. User 206 responds by selecting a time for viewing the status data. User interface 228 transfers the selected time to control module 540. Control module 540 then processes the selected time and the stored timestamps to determine whether user 206 is requesting a view of a graphical representation of current (live) status data or past (stored) status data.

In this example, user 206 indicates a time in the past as the selected time for viewing. Control module 540 transfers the stored status data correlated with the selected time from memory 224 to animation module 542. Animation module 542 processes the stored status data and generates a graphical representation of the stored status data. User interface 228 then receives the graphical representation of the stored status data and displays the graphical representation for user 206 to view.

Display system 200 continues to display a graphical representation of the stored status data from memory 224 until the stored status data stream catches up to the current time (and thus, the live status data stream) or until user 206 selects a different option.

FIG. 7 is a display diagram illustrating graphical representation 700. Note that graphical representation 700 has been simplified for illustrative purposes and does not represent an actual display. Computer system 205 processes status data from machine systems 201-203 to generate graphical representation 700. In graphical representation 700, status data variables are displayed relative to a time period. Horizontal axis 706 represents the time period on display. Vertical axis 708 indicates the range of possible values of the status data variables within the time period during which the values were captured. The plot of the status data variables versus correlated time points results in graph 702. As time goes by, horizontal axis 706 cycles through time points in sequence so that as a variable and its correlated time point move off of graphical representation 700 to the left, a new variable and correlated time point would move onto graphical representation 700 from the right. While graph 702 is drawn as a continuous graph with no discernible discontinuities, graph 702 may be a discrete graph emphasizing some or all of the particular values of the data variables that are captured. Further, horizontal axis 706 and vertical axis 708 may be annotated with numerical values indicating specific timestamps and variable values associated with graph 702. While horizontal axis 706 and vertical axis 708 are explicitly indicated in graphical representation 700, the axes 706 and 708 themselves may not be displayed in other implementations.

In one embodiment, the status data variables are process variables associated with an industrial process. These variables may include, for example, pressure, temperature, mass, volume, and flow rate of a solid, liquid, or gas medium, such as may be found in a conduit or other container. Such variables may further include any characteristic or property of matter that potentially varies with time. In one implementation, the values of each variable are captured by sensors coupled with the process being monitored, matched with an indication of the time at which the value was captured, and stored in memory for further display and analysis. This memory may reside within computer system 205, such as memory 224, or in a memory external to the computer system 205 which is accessible by processing system 222. In another embodiment, the variables may not be readings of properties of an actual process, but may instead represent potential values of a theoretical process mathematically generated within computer system 205. Further, in other embodiments, the variables may represent any time-variant value whose value may be associated with an event.

FIG. 8A is a display diagram illustrating graphical representation 800A. Graphical representation 800A comprises horizontal axis 808, vertical axis 806, graph 802, rewind option 803, play option 804, and fast-forward option 805. Horizontal axis 808 represents data variables V₁-V_{N}. Vertical axis 806 represents time points T₁-T_{P}. Tₚ represents the present, or current, time. Graph 802 is a plot of data variables V₁-V_{N} versus time points T₁-T_{P}. Rewind option 803, play option 804, and fast-forward option 805 are selectable by a user.

When a user selects rewind option 803, graph 802 moves to the left on horizontal axis 806 to a past time point selected by the user. For example, as graphical representation 800A rewinds, it displays the data variable at time T₀, T₋₁, T₋₂, etc. When the user selects fast-forward option 805, graph 802 moves to the right on horizontal axis 806 to a time point selected by the user that is later in time than the time being viewed. If the user fast-forwards to the present time, then graph 802 displays live status data. When the user selects a stop option or a pause option (not shown), then the graphical representation freezes the horizontal axis 806 until the user makes another selection. When the user selects play option 804, graph 802 displays status data beginning at a point in time where the graphical representation was last stopped.

FIG. 8B is a display diagram illustrating graphical representation 800B. Graphical representation 800B comprises horizontal axis 808, vertical axis 806, graph 802, and timebar 809. Horizontal axis 808 represents status data variables and vertical axis 806 represents time points. Graph 802 is a plot of the status data variables versus their correlated time points. Timebar 809 is selectable by a user.

In order to indicate a selected time for viewing, the user selects the portion of the timebar corresponding to the time the user wishes to view. Graph 802 moves to the right or the left on horizontal axis 806 to a time point selected by the user via the timebar.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of displaying automation data, the method comprising:
receiving first individual data points correlated with individual time points from a machine system;
storing the first individual data points in correlation with the individual time points;
receiving a user input indicating a selected time;
processing the selected time to determine if any of the individual time points are later in time than the selected time;
in response to determining that none of the individual time points are later in time than the selected time, displaying a graphical representation of second individual data points from the machine system; and
in response to determining that a one of the individual time points is later in time than the selected time, displaying a graphical representation of at least the individual data point correlated with the selected time.

2. The method of claim 1, further comprising, in response to determining that none of the individual time points are later in time than the selected time:
receiving the second individual data points from the machine system after receiving the user input indicating the selected time, processing the second individual data points, generating the graphical representation of the second individual data points, transferring the graphical representation to a user interface, and displaying the graphical representation in the user interface.

3. The method of claim 1, further comprising, in response to determining that the one of the individual time points is later in time than the selected time:
receiving the individual data point correlated with the selected time, processing the individual data point, generating the graphical representation of the individual data point, transferring the graphical representation to the user interface, and displaying the graphical representation in the user interface.

4. The method of claim 1, comprising, in response to determining that the one of the individual time points is later in time than the selected time, displaying a graphical representation of remaining individual data points correlated with individual time points later in time than the selected time.

5. The method of claim 1, wherein receiving the first individual data points from the machine system at individual time points comprises:
receiving a machine system variable that describes the operation of the machine system; and
receiving an individual time point that corresponds to a time that the machine system variable was generated.

6. The method of claim 1, comprising displaying options to a user and receiving the user input indicating one of the options.

7. The method of claim 6, further comprising processing the user input to determine the selected time.

8. The method of claim 6, wherein the options comprise fast-forward, rewind, and play.

9. The method of claim 6, wherein the options comprise a timebar.

10. A computer system comprising:
processing system configured to receive first individual data points correlated with individual time points from a machine system, store the first individual data points in correlation with the individual time points, receive a user input from a user indicating a selected time, and process the selected time to determine if any of the individual time points are later in time than the selected time;
in response to determining that none of the individual time points are later in time than the selected time, the processing system configured to display a graphical representation of second individual data points from the machine system; and
in response to determining that a one of the individual time points is later in time than the selected time, the processing system configured to display a graphical representation of at least the individual data point correlated with the selected time.

11. The computer system of claim 10, wherein, in response to determining that none of the individual time points are later in time than the selected time, the processing system is configured to receive the second individual data points from the machine system after receiving the user input indicating the selected time, process the second individual data points, generate the graphical representation of the second individual data points, transfer the graphical representation to a user interface, and display the graphical representation in the user interface.

12. The computer system of claim 10, wherein, in response to determining that the one of the individual time points is later in time than the selected time, the processing system is configured to receive the individual data point correlated with the selected time, process the individual data point, generate the graphical representation of the individual data point, transfer the graphical representation to the user interface, and display the graphical representation in the user interface.

13. The computer system of claim 10, wherein, in response to determining that the one of the individual time points is later in time than the selected time, the processing system is configured to display a graphical representation of remaining individual data points correlated with individual time points later in time than the selected time.

14. The computer system of claim 10, wherein receiving the first individual data points from the machine system at individual time points comprises:
the processing system configured to receive a machine system variable that describes the operation of the machine system; and
the processing system configured to receive an individual time point that corresponds to a time that the machine system variable was generated.

15. The computer system of claim 10, wherein the processing system is configured to display options to the user and receive the user input indicating one of the options.

16. The computer system of claim 15, wherein the processing system is configured to process the user input to determine the selected time.

17. The computer system of claim 15, wherein the options comprise fast-forward, rewind, and play.

18. The computer system of claim 15, wherein the options comprise a timebar.

19. A computer-readable medium having instruction stored thereon for operating a system to display automation data, wherein the instructions, when executed by the communication system, direct the system to:
receive first individual data points correlated with individual time points from a machine system;
store the first individual data points in correlation with the individual time points;
receive a user input indicating a selected time;
process the selected time to determine if any of the individual time points are later in time than the selected time;
in response to determining that none of the individual time points are later in time than the selected time, display a graphical representation of second individual data points from the machine system; and
in response to determining that a one of the individual time points is later in time than the selected time, display a graphical representation of at least the individual data point correlated with the selected time.

20. The computer-readable medium of claim 19, wherein, in response to determining that none of the individual time points are later in time than the selected time, the instructions direct the system to:
receive the second individual data points from the machine system after receiving the user input indicating the selected time, process the second individual data points, generate the graphical representation of the second individual data points, transfer the graphical representation to a user interface, and display the graphical representation in the user interface.

21. The computer-readable medium of claim 19, wherein, in response to determining that the one of the individual time points is later in time than the selected time, the instructions direct the system to:
receive the individual data point correlated with the selected time, process the individual data point, generate the graphical representation of the individual data point, transfer the graphical representation to the user interface, and display the graphical representation in the user interface.

22. The computer-readable medium of claim 19, wherein, in response to determining that the one of the individual time points is later in time than the selected time, the instructions direct the system to display a graphical representation of remaining individual data points correlated with individual time points later in time than the selected time.

23. The computer-readable medium of claim 19, wherein the instructions direct the system to:
receive a machine system variable that describes the operation of the machine system; and
receive an individual time point that corresponds to a time that the machine system variable was generated.

24. The computer-readable medium of claim 19, wherein the instructions direct the system to display options to a user and receive the user input indicating one of the options.

25. The computer-readable medium of claim 24, wherein the instructions direct the system to process the user input to determine the selected time.

26. The computer-readable medium of claim 24, wherein the options comprise fast-forward, rewind, and play.

27. The computer-readable medium of claim 24, wherein the options comprise a timebar.
